(19) United States
(12) Patent Application Publication
(10) Pub. No.: US 2026/0162328 A1
(43) Pub. Date: Jun. 11, 2026

(54) REPOSITIONING, REPLACING, AND GENERATING OBJECTS IN AN IMAGE

(71) Applicant: Google LLC, Mountain View, CA (US)

(72) Inventors: Bryan FELDMAN, Mountain View, CA (US); Matan COHEN, Mountain View, CA (US); Shlomi FRUCHTER, Mountain View, CA (US); Yael Pritch KNAAN, Mountain View, CA (US); Alex Rav ACHA, Mountain View, CA (US); Noam PETRANK, Mountain View, CA (US); Andrey VOYNOV, Mountain View, CA (US); Amir HERTZ, Mountain View, CA (US); Amir LELLOUCHE, Mountain View, CA (US)

(73) Assignee: Google LLC, Mountain View, CA (US)

(21) Appl. No.: 19/135,776

(22) PCT Filed: May 9, 2024
(86) PCT No.: PCT/US2024/028642

§ 371 Date: Jun. 4, 2025

Related U.S. Application Data
(60) Provisional application No. 63/465,230, filed on May 9, 2023.
(60) Provisional application No. 63/562,634, filed on Mar. 7, 2024.

(51) Int. Cl. G06T 11/60; G06T 3/40; G06T 5/77; G06T 7/11

(52) U.S. Cl. CPC G06T 11/60; G06T 3/40; G06T 5/77; G06T 7/11; G06T 2200/24; G06T 2207/20092; G06T 2207/20132

(57) ABSTRACT

A media application receives a selection of an incomplete object in an initial image. The media application generates an object mask that includes incomplete object pixels associated with the incomplete object. The media application removes the incomplete object pixels associated with the incomplete object from the initial image. The media application generates an inpainted image that replaces the incomplete object pixels corresponding to the incomplete object with inpainted pixels. The media application outputs a complete object. The media application outputs a modified image by blending one or more versions of the complete object with one or more versions of the inpainted image using the object mask.

### CROSS-REFERENCE TO RELATED APPLICATIONS

The present application claims priority to U.S. Provisional Patent Application No. 63/465,230, filed May 9, 2023, and titled “Repositioning Objects in an Image,” and U.S. Provisional Patent Application No. 63/562,634, filed Mar. 7, 2024 and titled “Performing Scene Impact Editing Tasks Using Diffusion Neural Networks,” each of which is incorporated herein in its entirety.

### BACKGROUND

A user may capture an image where objects are in undesirable locations. For example, an object may be cut off by a border of the image, cut off by another object, etc. Techniques exist for moving objects within images; however, attempts at moving the objects to different locations in the image can have disastrous results. For example, pixels associated with an object may be improperly identified such that a portion of the object stays in an original location while a remaining portion of the object is moved to a different location (e.g., a body of a chicken is moved while the feet of the chicken remain behind). In another example, the empty spaces caused by removing pixels associated with a moved object may be filled in with pixels that look out of place. In yet another example, the pixels surrounding a moved object may look different from the background and result in an image that looks poorly edited.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method includes receiving a selection of an incomplete object in an initial image, wherein the incomplete object is associated with a first location within the initial image and an omitted portion of the incomplete object is cut off by a boundary of the initial image or obscured by another object. The method further includes generating an object mask that includes incomplete object pixels associated with the incomplete object. The method further includes removing the incomplete object pixels associated with the incomplete object from the initial image. The method further includes generating an inpainted image that replaces the incomplete object pixels corresponding to the incomplete object with inpainted pixels. The method further includes providing, as input to a diffusion model, the object mask, the incomplete object, and the inpainted image. The method further includes outputting, with the diffusion model, a complete object. The method further includes generating a modified image by blending one or more versions of the complete object with one or more versions of the inpainted image using the object mask, wherein the complete object is positioned at a second location in the modified image that is different from the first location in the initial image.

In some embodiments, the modified image is a first modified image and the method further includes receiving a request to remove a selected object from the first modified image; providing the first modified image and the request as input to an object removal model associated with the diffusion model; and outputting, with the object removal model, a second modified image that does not include the selected object. In some embodiments, the modified image is a first modified image and the method further includes receiving a request to move a selected object from a third location to a fourth location; providing the first modified image and the request as input to an object insertion model associated with the diffusion model; and outputting, with the object insertion model, a second modified image that includes the selected object at the fourth location based on the request.

In some embodiments, the modified image is a first modified image and the method further includes receiving a request to add an additional object to the initial image; outputting, with the diffusion model, the additional object; and outputting, with the diffusion model, a second modified image by blending one or more versions of the additional object with one or more versions of the inpainted image. In some embodiments, the request to add the additional object includes a text prompt that describes the additional object.

In some embodiments, the complete object is resized based on a change from the first location in the initial image to the second location in the modified image. In some embodiments, the method further includes receiving a command to uncrop the modified image to extend uncropped borders of the modified image to extended borders and outputting an uncropped image that includes inpainted pixels between the uncropped borders of the modified image and the extended borders based on the command. In some embodiments, the command to uncrop the inpainted image includes: a selection of an uncrop button and either an command to directly extend the uncropped borders of the modified image to the extended borders or a movement of the complete object that extends the uncropped borders of the modified image to the extended borders. In some embodiments, the method further includes modifying a lighting of the modified image; and adding a shadow to the complete object based on a direction of the lighting of the modified image.

In some embodiments, a non-transitory computer-readable medium with instructions stored thereon that, when executed by one or more processors, cause the one or more processors to perform operations. The operations include receiving a selection of an incomplete object in an initial image, where the incomplete object is associated with a first location within the initial image and an omitted portion of the incomplete object is cut off by a boundary of the initial image or obscured by another object; generating an object mask that includes incomplete object pixels associated with the incomplete object; removing the incomplete object pixels associated with the incomplete object from the initial image; generating an inpainted image that replaces the incomplete object pixels corresponding to the incomplete object with inpainted pixels; providing, as input to a diffusion model, the object mask, the incomplete object, and the inpainted image; outputting, with the diffusion model, a complete object; and generating a modified image by blending one or more versions of the complete object with one or more versions of the inpainted image using the object mask, wherein the complete object is positioned at a second location in the modified image that is different from the first location in the initial image.

In some embodiments, the modified image is a first modified image and the operations further include receiving a request to remove a selected object from the first modified image; providing the first modified image and the request as input to an object removal model associated with the diffusion model; and outputting, with the object removal model, a second modified image that does not include the selected object. In some embodiments, the modified image is a first modified image and the operations further include receiving a request to move a selected object from a third location to a fourth location; providing the first modified image and the request as input to an object insertion model associated with the diffusion model; and outputting, with the object insertion model, a second modified image that includes the selected object at the fourth location based on the request.

In some embodiments, the modified image is a first modified image and the operations further include: receiving a request to add an additional object to the initial image, the request including a text prompt that describes the additional object; outputting, with the diffusion model, the additional object; and outputting, with the diffusion model, a second modified image by blending one or more versions of the additional object with one or more versions of the inpainted image. In some embodiments, the complete object is resized based on a change from the first location in the initial image to the second location in the modified image. In some embodiments, the operations further include receiving a command to uncrop the modified image to extend uncropped borders of the modified image to extended borders and outputting an uncropped image that includes inpainted pixels between the uncropped borders of the modified image and the extended borders based on the command.

In some embodiments, a system includes a processor and a memory coupled to the processor, with instructions stored thereon that, when executed by the processor, cause the processor to perform operations. The operations include receiving a selection of an incomplete object in an initial image, where the incomplete object is associated with a first location within the initial image and an omitted portion of the incomplete object is cut off by a boundary of the initial image or obscured by another object; generating an object mask that includes incomplete object pixels associated with the incomplete object; removing the incomplete object pixels associated with the incomplete object from the initial image; generating an inpainted image that replaces the incomplete object pixels corresponding to the incomplete object with inpainted pixels; providing, as input to a diffusion model, the object mask, the incomplete object, and the inpainted image; outputting, with the diffusion model, a complete object; and generating a modified image by blending one or more versions of the complete object with one or more versions of the inpainted image using the object mask, wherein the complete object is positioned at a second location in the modified image that is different from the first location in the initial image.

In some embodiments, the modified image is a first modified image and the operations further include receiving a request to remove a selected object from the first modified image; providing the first modified image and the request as input to an object removal model associated with the diffusion model; and outputting, with the object removal model, a second modified image that does not include the selected object. In some embodiments, the modified image is a first modified image and the operations further include receiving a request to move a selected object from a third location to a fourth location; providing the first modified image and the request as input to an object insertion model associated with the diffusion model; and outputting, with the object insertion model, a second modified image that includes the selected object at the fourth location based on the request.

In some embodiments, the modified image is a first modified image and the operations further include: receiving a request to add an additional object to the initial image, the request including a text prompt that describes the additional object; outputting, with the diffusion model, the additional object; and outputting, with the diffusion model, a second modified image by blending one or more versions of the additional object with one or more versions of the inpainted image. In some embodiments, the complete object is resized based on a change from the first location in the initial image to the second location in the modified image. In some embodiments, the operations further include receiving a command to uncrop the modified image to extend uncropped borders of the modified image to extended borders and outputting an uncropped image that includes inpainted pixels between the uncropped borders of the modified image and the extended borders based on the command.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIG. 3A illustrates an example initial image, according to some embodiments described herein.

FIG. 3B illustrates an example initial image where the two objects from FIG. 3A were selected for modification, according to some embodiments described herein.

FIG. 3C illustrates an example initial image with masks surrounding the objects, according to some embodiments described herein.

FIG. 3D illustrates an example inpainted image with a bystander object removed and the subject object moved and resized, according to some embodiments described herein.

FIG. 3E illustrates an example inpainted image with the road replaced with grass, a first type of tree replaced with a second type of tree, and a cloudy sky replaced with a clear sky, according to some embodiments described herein.

FIG. 4A illustrates an example initial image of a child sitting on a bench and holding balloons that are partially cut off by a boundary of the initial image, according to some embodiments described herein.

FIG. 4B illustrates an example modified image where the child, the bench, and the balloons are moved to a second location, according to some embodiments described herein.

FIG. 5A illustrates an example user interface of an initial image that includes a button for changing a border of an initial image, according to some embodiments described herein.

FIG. 5B illustrates an example user interface with an indicator that is used to expand a border of the initial image, according to some embodiments described herein.

FIG. 5C illustrates an example user interface of an uncropped image that is output based on the initial image, according to some embodiments described herein.

FIG. 5D illustrates an alternative example user interface where a selected object is used to extend a border of the initial image, according to some embodiments described herein.

FIG. 6 illustrates an example flowchart of a method to generate a modified image of a complete object from an incomplete object, according to some embodiments described herein.

FIG. 7 illustrates an example flowchart of a method to output an uncropped image from an initial image, according to some embodiments described herein.

FIG. 8 illustrates an example flowchart of a method to train an object removal model, according to some embodiments described herein.

FIG. 9 illustrates an example flowchart of a method to train an object insertion model, according to some embodiments described herein.

### DETAILED DESCRIPTION

A user may capture an image where objects are in undesirable locations. For example, an object may be cut off by a border of the image, cut off by another object, etc. Techniques exist for moving objects within images; however, attempts at moving the objects to different locations in the image can have disastrous results. For example, pixels associated with an object may be improperly identified such that a portion of the object stays in an original location while a remaining portion of the object is moved to a different location (e.g., a body of a chicken is moved while the feet of the chicken remain behind). In another example, the empty spaces caused by removing pixels associated with a moved object may be filled in with pixels that look out of place. In yet another example, the pixels surrounding a moved object may look different from the background and result in an image that looks poorly edited.

The technology described below advantageously solves these problems by providing an incomplete object as input to a diffusion machine-learning model, referred to as a diffusion model herein, and outputting a complete object. An incomplete object is a partial representation of an object in an image. The object is present in the image partially (and not fully). A portion of the object, which is not present in the image, is referred to herein as the “omitted portion” of the incomplete object. A user may select the incomplete object in an initial image and move the location of the incomplete object.

The space left by the incomplete object is inpainted with inpainted pixels to form an inpainted image. A complete object is a complete representation of the object including the incomplete object and the omitted portion of the incomplete object. An inpainted image is an image differs from the initial image in that incomplete object pixels associated with the incomplete object are removed from the inpainted image and the incomplete object pixels are replaced with inpainted pixels that may be selected based on a proximity to surrounding pixels, selected from a reference image that includes background pixels, etc.

The diffusion model ensures that the complete object fits in the new location. For example, if an object is moved from a background to a foreground, the diffusion model increases the size of the moved object. The diffusion model outputs a modified image where the complete object is seamlessly merged with the inpainted image by blending one or more versions of the complete object with one or more versions of the inpainted image using the object mask. For example, the diffusion model may blend progressively noisier versions of the complete object with corresponding noisy versions of the inpainted image while also generating denoised versions of the complete object and corresponding denoised versions of the inpainted image. A noisy version of the complete object is created by increasing the entropy of the image where more noise makes the details of the complete object less discernable in the image. Similarly, a noisy version of the inpainted image is created by increasing the entropy of the inpainted image where more noise makes the details of the inpainted image less discernable.

By employing the diffusion model instead of other machine-learning models, the media application maintains a realistic appearance of the modified image under a wide variety of situations. The technology described below enables correcting defective images, i.e. images comprising incomplete objects, in an efficient way. Complete objects, created by utilizing the diffusion model, have a high quality and are without the errors described above. The image processing described herein effectively and efficiently corrects images with regard to incomplete objects present in the images.

### Example Environment 100

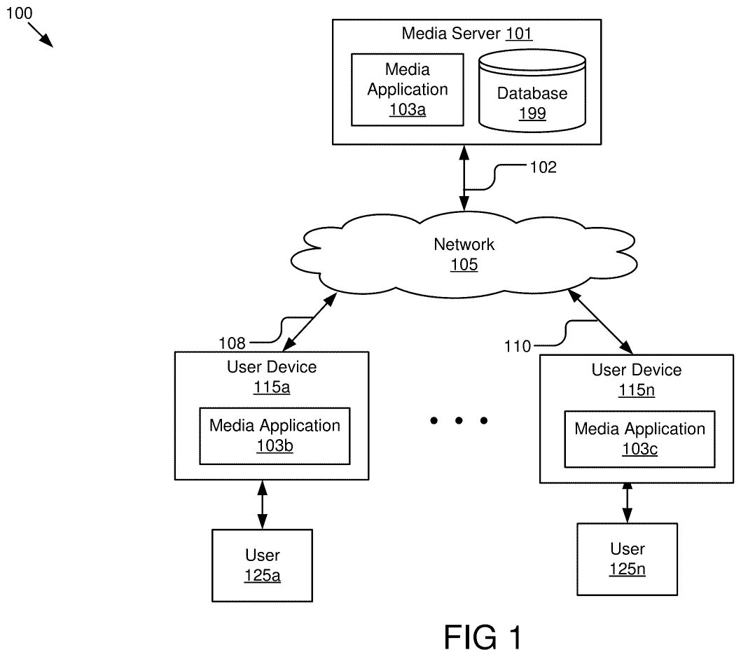

FIG. 1 illustrates a block diagram of an example environment 100. In some embodiments, the environment 100 includes a media server 101, a user device 115a, and a user device 115n coupled to a network 105. Users 125a, 125n may be associated with respective user devices 115a, 115n. In some embodiments, the environment 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The media server 101 may include a processor, a memory, and network communication hardware. In some embodiments, the media server 101 is a hardware server. The media server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the media server 101 sends and receives data to and from one or more of the user devices 115a, 115n via the network 105. The media server 101 may include a media application 103a and a database 199.

The database 199 may store machine-learning models, training data sets, images, etc. The database 199 may also store social network data associated with users 125, user preferences for the users 125, etc.

The user device 115 may be a computing device that includes a memory coupled to a hardware processor. For example, the user device 115 may include a mobile device, a tablet computer, a mobile telephone, a wearable device, a head-mounted display, a mobile email device, a portable game player, a portable music player, a reader device, or another electronic device capable of accessing a network 105.

In the illustrated embodiment, user device 115a is coupled to the network 105 via signal line 108 and user device 115n is coupled to the network 105 via signal line 110. The media application 103 may be stored as media application 103b on the user device 115a and/or media application 103c on the user device 115n. Signal lines 108 and 110 may be wired connections, such as Ethernet, coaxial cable, fiber-optic cable, etc., or wireless connections, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

The media application 103 may be stored on the media server 101 or the user device 115. In some embodiments, the operations described herein are performed on the media server 101 or the user device 115. In some embodiments, some operations may be performed on the media server 101 and some may be performed on the user device 115. Performance of operations is in accordance with user settings. For example, the user 125a may specify settings that operations are to be performed on their respective device 115a and not on the media server 101. With such settings, operations described herein are performed entirely on user device 115a and no operations are performed on the media server 101. Further, a user 125a may specify that images and/or other data of the user is to be stored only locally on a user device 115a and not on the media server 101. With such settings, no user data is transmitted to or stored on the media server 101. Transmission of user data to the media server 101, any temporary or permanent storage of such data by the media server 101, and performance of operations on such data by the media server 101 are performed only if the user has agreed to transmission, storage, and performance of operations by the media server 101. Users are provided with options to change the settings at any time, e.g., such that they can enable or disable the use of the media server 101.

Machine learning models (e.g., diffusion models, neural networks or other types of models), if utilized for one or more operations, are stored and utilized locally on a user device 115, with specific user permission. Server-side models are used only if permitted by the user. Further, a trained model may be provided for use on a user device 115. During such use, if permitted by the user 125, on-device training of the model may be performed. Updated model parameters may be transmitted to the media server 101 if permitted by the user 125, e.g., to enable federated learning. Model parameters do not include any user data.

The media application 103 receives an initial image. For example, the media application 103 receives an initial image from a camera that is part of the user device 115 or the media application 103 receives the initial image over the network 105. The media application 103 receives a selection of an incomplete object in the initial image. The incomplete object is associated with a first location within the initial image and an omitted portion of the incomplete object is cut off by a boundary of the initial image or obscured by another object. The incomplete object may be selected when a user 125 taps on the object, draws a shape (e.g., a circle) around the object, confirms a suggestion by the media application 103 to modify the object, etc.

The media application 103 generates an object mask that includes incomplete object pixels associated with the incomplete object and removes the incomplete object pixels associated with the incomplete object from the initial image. The media application 103 generates an inpainted image that replaces incomplete object pixels corresponding to the incomplete object with inpainted pixels.

The media application 103 outputs, with a diffusion model, a complete object. For example, where an incomplete object is cut off by the edges of an initial image and the incomplete object is moved to the center of the initial image, the diffusion model outputs a complete object that fills in the missing portion of the incomplete object. The media application 103 outputs, with the diffusion model, a modified image by blending one or more versions of the complete object with one or more versions of the inpainted image using the object mask, wherein the complete object is positioned at a second location in the modified image that is different from the first location in the initial image. In some embodiments, the modified image may include a watermark or other indicator to identify that the modified image was generated using a machine-learning model.

In some embodiments, the media application 103 may be implemented using hardware including a central processing unit (CPU), a field-programmable gate array (FPGA), an application-specific integrated circuit (ASIC), machine learning processor/co-processor, any other type of processor, or a combination thereof. In some embodiments, the media application 103a may be implemented using a combination of hardware and software.

### Example Computing Device 200

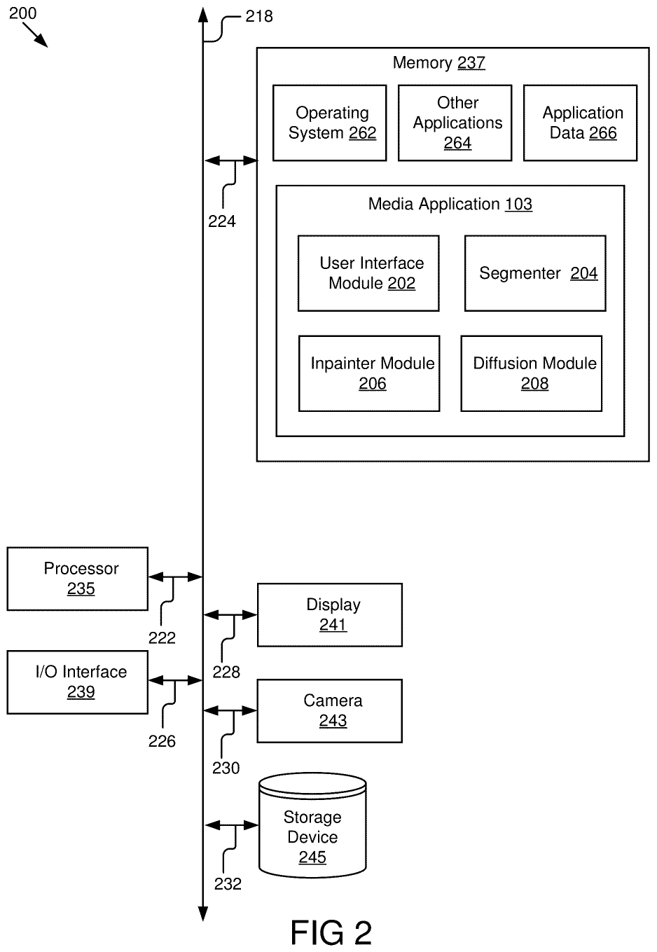

FIG. 2 is a block diagram of an example computing device 200 that may be used to implement one or more features described herein. Computing device 200 can be any suitable computer system, server, or other electronic or hardware device. In one example, computing device 200 is media server 101 used to implement the media application 103a. In another example, computing device 200 is a user device 115.

In some embodiments, computing device 200 includes a processor 235, a memory 237, an input/output (I/O) interface 239, a display 241, a camera 243, and a storage device 245 all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, the camera 243 may be coupled to the bus 218 via signal line 230, and the storage device 245 may be coupled to the bus 218 via signal line 232.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output, e.g., the output produced by processor 235 may be imprecise or may be accurate within a range from an expected output. Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is provided in computing device 200 for access by the processor 235, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., an image library application, an image management application, an image gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include images used by the image library application and user actions identified by the other applications 264 (e.g., a social networking application), etc.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 245), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. For example, display 241 may be utilized to display a user interface that includes a graphical guide on a viewfinder. Display 241 can include any suitable display device such as a liquid crystal display (LCD), light emitting diode (LED), or plasma display screen, cathode ray tube (CRT), television, monitor, touchscreen, three-dimensional display screen, or other visual display device. For example, display 241 can be a flat display screen provided on a mobile device, multiple display screens embedded in a glasses form factor or headset device, or a monitor screen for a computer device.

Camera 243 may be any type of image capture device that can capture images and/or video. In some embodiments, the camera 243 captures images or video that the I/O interface 239 transmits to the media application 103.

The storage device 245 stores data related to the media application 103. For example, the storage device 245 may store a training data set that includes labeled images, a machine-learning model, output from the machine-learning model, etc.

FIG. 2 illustrates an example media application 103, stored in memory 237, that includes a user interface module 202, a segmenter 204, an inpainter module 206, and a diffusion module 208.

The user interface module 202 generates graphical data for displaying a user interface that includes images. In some embodiments, the user interface module 202 receives an initial image. The initial image may be received from the camera 243 of the computing device 200 or from the media server 101 via the I/O interface 239. The initial image includes a subject, such as a person. In some embodiments, the user interface includes options for selecting various people and other objects in the initial image. For example, a user may select a person by tapping on the person, circling an object, brushing an object, etc. In some embodiments, the user interface generates recommendations for modifying the image, such as displaying text asking if the user wants a bystander removed from the object.

In some embodiments, once a user selects an object the user interface module 202 updates the graphical data to include a highlighted version of the selected object. A user may modify the selected object. For example, the user may drag and drop the selected object from a first location to a second location, the user may resize the image, the user may select a button to erase the image, etc.

In some embodiments, the segmenter 204 generates a segmentation score that reflects a quality of identification of pixels associated with the selected object in the initial image. The user interface may include different options for modifying the selected object based on the segmentation score. For example, if the segmentation score exceeds a threshold value, the user interface module 202 provides an option to move the selected object, replace the selected object with a different object, or erase the selected object. In another example, if the segmentation score does not exceed the threshold value, the user interface module 202 does not provide an option to move the selected object but does provide the options of replacing the selected object or erasing the selected object.

In some embodiments, the user interface module 202 generates graphical data for displaying an inpainted image where a selected object is moved from a first location to a second location within the image, the selected image is resized, an additional object is added, etc. The user interface may also include options for editing the inpainted image, sharing the inpainted image, adding the inpainted image to a photo album, etc.

The segmenter 204 segments a selected object from an initial image by identifying pixels that correspond to the selected object. In some embodiments, the segmenter 204 uses an alpha map as part of a technique for distinguishing the foreground and background of the initial image during segmentation. The segmenter 204 may also identify a texture of the selected object in the foreground of the initial image. In some embodiments, the segmenter 204 generates a segmentation map that identifies pixels that are associated with one or more objects in the initial image. For example, the segmentation map may include an identification of pixels associated with the selected object.

The segmenter 204 may perform the segmentation by detecting objects in an initial image. The object may be a person, an animal, a car, a building, etc. A person may be a subject of the initial image or is not the subject of the initial image (i.e., a bystander). A bystander may include people walking, running, riding a bicycle, standing behind the subject, or otherwise within the initial image. In different examples, a bystander may be in the foreground (e.g., a person crossing in front of the camera), at the same depth as the subject (e.g., a person standing to the side of the subject), or in the background. In some examples, there may be more than one bystander in the initial image. The bystander may be a human in an arbitrary pose, e.g., standing, sitting, crouching, lying down, jumping, etc. The bystander may face the camera, may be at an angle to the camera, or may face away from the camera.

The segmenter 204 may detect types of objects by performing object recognition, comparing the objects to object priors of people, vehicles, buildings, etc. to identify expected shapes of objects in order to determine whether pixels are associated with a selected object or a background. The segmenter 204 may generate a region of interest for the selected object, such as a bounding box with x, y coordinates and a scale.

The segmenter 204 generates one or more object masks for one or more selected objects in the initial image. The object mask represents a region of interest. The object mask is described in greater detail below with reference to the diffusion model.

In some embodiments, one or more object masks are generated based on generating superpixels for the image and matching superpixel centroids to depth map values (e.g., obtained by the camera 243 using a depth sensor or by deriving depth from pixel values) to cluster detections based on depth. More specifically, depth values in a masked area may be used to determine a depth range and superpixels may be identified that fall within the depth range. Another technique for generating a mask includes weighing depth values based on how close the depth values are to the object mask where weights were represented by a distance transform map.

In some embodiments, the segmenter 204 uses a machine-learning algorithm, such as a neural network or more specifically, a convolutional neural network, to segment the initial image and generate the object mask. The segmenter 204 may specify a circuit configuration (e.g., for a programmable processor, for a field programmable gate array (FPGA), etc.) enabling processor 235 to apply a machine-learning model. In some embodiments, the segmenter 204 may include software instructions, hardware instructions, or a combination. In some embodiments, the segmenter 204 may offer an application programming interface (API) that can be used by the operating system 262 and/or other applications 264 to invoke the segmenter 204 e.g., to apply the machine-learning model to application data 266 to output the object mask.

The segmenter 204 uses training data to generate a trained machine-learning model. For example, training data may include pairs of initial images with one or more objects and output images with one or more corresponding object masks.

Training data may be obtained from any source, e.g., a data repository specifically marked for training, data for which permission is provided for use as training data for machine learning, etc. In some embodiments, the training may occur on the media server 101 that provides the training data directly to the user device 115, the training occurs locally on the user device 115, or a combination of both.

In some embodiments, the segmenter 204 uses weights that are taken from another application and are unedited/transferred. For example, in these embodiments, the trained model may be generated, e.g., on a different device, and be provided as part of the segmenter 204. In various embodiments, the trained model may be provided as a data file that includes a model structure or form (e.g., that defines a number and type of neural network nodes, connectivity between nodes and organization of the nodes into a plurality of layers), and associated weights. The segmenter 204 may read the data file for the trained model and implement neural networks with node connectivity, layers, and weights based on the model structure or form specified in the trained model.

The trained machine-learning model may include one or more model forms or structures. For example, model forms or structures can include any type of neural-network, such as a linear network, a deep-learning neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

The model form or structure may specify connectivity between various nodes and organization of nodes into layers. For example, nodes of a first layer (e.g., an input layer) may receive data as input data or application data. Such data can include, for example, one or more pixels per node, e.g., when the trained model is used for analysis, e.g., of an initial image. Subsequent intermediate layers may receive as input, output of nodes of a previous layer per the connectivity specified in the model form or structure. These layers may also be referred to as hidden layers. For example, a first layer may output a segmentation between a foreground and a background. A final layer (e.g., output layer) produces an output of the machine-learning model. For example, the output layer may receive the segmentation of the initial image into a foreground and a background and output whether a pixel is part of an object mask or the rest of the initial image. In some embodiments, the model form or structure also specifies a number and/or type of nodes in each layer.

In different embodiments, the trained model can include one or more models. One or more of the models may include a plurality of nodes, arranged into layers per the model structure or form. In some embodiments, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some embodiments, the computation performed by a node may also include applying a step/activation function to the adjusted weighted sum. In some embodiments, the step/activation function may be a nonlinear function. In various embodiments, such computation may include operations such as matrix multiplication. In some embodiments, computations by the plurality of nodes may be performed in parallel, e.g., using multiple processors cores of a multicore processor, using individual processing units of a graphics processing unit (GPU), or special-purpose neural circuitry. In some embodiments, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM).

In some embodiments, the trained model may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using training data, to produce a result.

Training may include applying supervised learning techniques. In supervised learning, the training data can include a plurality of inputs (e.g., initial images, object masks, object masks, etc.) and a corresponding groundtruth output for each input (e.g., a groundtruth mask that correctly identifies the object in each image). Based on a comparison of the output of the model with the groundtruth output, values of the weights are automatically adjusted, e.g., in a manner that increases a probability that the model produces the groundtruth output for the image.

In various embodiments, a trained model includes a set of weights, or embeddings, corresponding to the model structure. In some embodiments, the trained model may include a set of weights that are fixed, e.g., downloaded from a server that provides the weights. In various embodiments, a trained model includes a set of weights, or embeddings, corresponding to the model structure. In embodiments where data is omitted, the segmenter 204 may generate a trained model that is based on prior training, e.g., by a developer of the segmenter 204, by a third-party, etc. In some embodiments, the trained model may include a set of weights that are fixed, e.g., downloaded from a server that provides the weights.

In some embodiments, the trained machine-learning model receives an initial image with one or more selected objects. In some embodiments, the trained machine-learning model outputs one or more object masks that include the one or more objects.

After the one or more object masks are output by the segmenter 204 (e.g., from the machine-learning model), the segmenter 204 removes the one or more selected objects from the initial image.

The inpainter module 206 generates an inpainted image that replaces object pixels corresponding to one or more objects with inpainted pixels. The inpainted pixels may be based on pixels from a reference image of the same location without the objects. Alternatively, the inpainter module 206 may identify inpainted pixels to replace the removed object based on a proximity of the inpainted pixels to other pixels that surround the object. The inpainter module 206 may use a gradient of neighborhood pixels to determine properties of the inpainted pixels. For example, where a bystander was standing on the ground, the inpainter module 206 replaces the inpainted pixels with pixels of the ground. Other inpainting techniques are possible, including a machine-learning based inpainter technique that outputs inpainted pixels based on training data that includes images of similar structures.

In embodiments where a user chose to erase the selected object, the user interface module 202 may display the inpainted image where the selected object was removed and the selected object pixels were replaced with inpainted pixels.

In embodiments where the user chooses to move the selected object, replace the selected object, or add an object to an image, a diffusion module 208 performs blending of an object with an object mask and an inpainted image using a diffusion model. The diffusion model may receive an object mask, an incomplete object, and an inpainted image as input. The diffusion model may receive additional inputs, such as a text request, a number of pixels to be filled to output a complete object based on an incomplete object, dimensions for a modified image, etc.

Diffusion models include a forward process where the diffusion model adds noise to the data and a reverse process where the diffusion model learns to recover the data from the noise. For example, where a selected object is moved from a first location to a second location, the diffusion module 208 applies the diffusion model by blending the selected object with progressively noisier versions and then progressively denoised versions of the inpainted image. In some embodiments, an object stitch diffusion model is used to move an object from a first location to a second location. In some embodiments, a generation diffusion model is used when the object is an incomplete object and a portion of the object is generated and/or for new objects that are generated from text prompts.

### Object Stitch Diffusion Model

In some embodiments, the object stitch diffusion model is used when an object is moved from a first location to a second location. In some embodiments, the diffusion module 208 includes an object image encoder that extracts semantic features from a selected object, a diffusion model that blends an object with an image, and a content adaptor that transforms a sequence of visual tokens to a sequence of text tokens to overcome a domain gap between image and text. In some embodiments, the diffusion module 208 trains the diffusion model using self-supervision based on training data where the training data includes image and text pairs. In some embodiments, the diffusion model is trained on synthetic data that simulates real-world scenarios. The diffusion model may also be trained using data augmentation that is generated by introducing random shift and crop augmentations during training, while ensuring that the foreground object is contained within the crop window.

The content adaptor is trained during a first stage using the image and text pairs to maintain high-level semantics of the object and during a second stage the content adaptor is trained in the context of the diffusion model to encode key identity features of the object by encouraging the visual reconstruction of the object in the original image. The diffusion model may be trained on an embedding produced by the content adaptor through cross-attention blocks.

The diffusion model uses an object mask to blend the inpainted image with the object. The diffusion model may denoise the masked area. The content adaptor may transform the visual features from the object image encoder to text features (tokens) to use as conditioning for the diffusion model.

### Generative Diffusion Model

In some embodiments, the generative diffusion model is used to output a complete object based on an incomplete object or to generate a new object. The diffusion module 208 trains the generative diffusion model based on training data. The training data may include image and text pairs that are used to create an embedding space for images and text. The image and text pairs may include an image that is associated with corresponding text, such as an image of a dog and text that includes “pitbull.” The diffusion module 208 may be trained with a loss that reflects a cosine distance between an embedding of a text prompt and an embedding of an estimated clean image (i.e., with no text-generated objects).

The diffusion module 208 may use the training data to perform text conditioning, where text conditioning describes the process of outputting objects that are conditioned on a text prompt. The diffusion module 208 may train a neural network to output the object based on the text prompt provided by a user or by the media application. For example, the text prompt may be a suggestion generated by the media application based on the context of the initial image (e.g., where the initial image is a beach, the text prompt may be for a beach ball, a turtle, etc.).

In some embodiments, the diffusion module 208 may output at least a portion of a missing part of an object based on receiving an incomplete object as input data, a location within the image where the incomplete object is being moved, and dimensions of the output (e.g., the original dimensions or modified dimensions if the object is resized). For example, if a user selects an object in a user interface that is partially cut off by a boundary and moves the object from a first location to a second location where the second location also cuts off part of the object, the diffusion module 208 may output a modified object that includes more of the object that is visible based on moving the object in the image. In some embodiments, the diffusion module 208 may output a complete object based on an incomplete object selected by a user. For example, where a user selected a beach ball that is partially obscured by another object, the diffusion model may be trained to output a complete beach ball.

In some embodiments, the diffusion module 208 generates progressively noisier versions of the complete object as compared to a previous version and progressively noisier versions of the inpainted image as compared to a previous version. For example, a forward Markovian noising process produces a series of noisy inpainted images by gradually adding Gaussian noise until a nearly isotropic Gaussian noise sample is obtained. The forward noising process defines a progression of image manifolds, where each manifold consists of noising images.

The diffusion module 208 may spatially blend noisy versions of the complete object with corresponding noisy versions of the inpainted image using the object mask. For example, the diffusion module 208 may blend each noisy version of the complete object with each corresponding noisy version of the inpainted image using the object mask where the object mask delineates the boundaries of the complete object such that the object mask delineates the area that is modified during the blending process. In some embodiments, the diffusion process may include a local complete-object guided diffusion where the image generation loss determined during the training process is used under the object mask during location object-generation diffusion.

The diffusion module 208 may perform a diffusion step that denoises a latent space in a direction dependent on a text prompt. The diffusion module 208 generates progressively denoised versions of the complete object as compared to a previous version and progressively denoised versions of the inpainted image as compared to a previous version. For example, the reverse Markovian process transforms a Gaussian noise sample by repeatedly denoising the inpainted image using a learned posterior. Each step of the denoising diffusion process projects a noisy image onto the next, less noisy manifold.

The diffusion module 208 performs the denoising diffusion step after each blend to restore coherence by projecting onto the next manifold. Once the spatial blending is complete, the diffusion module 208 preserves the background by replacing a region outside the object mask with a corresponding region from the inpainted image.

In some embodiments, the diffusion module 208 uses cross-domain compositing to apply an iterative refinement scheme to infuse an object with contextual information to make the object match the style of the inpainted image. For example, if the object is generated for an indoor setting and is added to an outdoor inpainted image, the object may be modified to be brighter to match the inpainted image. In another example, if the object was located at a first location in a shadow and the second location is in full sun, the object may be modified to match the brightness of the second location.

### Object Removal Model

In some embodiments, instead of using the segmenter 204 to remove an object and using the inpainter module 206 to add pixels to the removed area in an initial image, the diffusion model 208 is trained to include an object removal model.

The diffusion module 208 generates counterfactual training data to train the diffusion model to include an object removal model. For each counterfactual image pair, the diffusion module 208 captures a factual image that contains an object in a scene; physically removes the object while avoiding camera movement, lighting changes, or motion of other objects; captures a counterfactual image of the scene without the object, and segments the factual image to create an object mask. Segmenting the factual image includes creating a segmentation map (Mₒ) for the object O removed from the factual image X.

The diffusion module 208 creates, for each image pair, a combined image that includes the factual image and the object mask and the counterfactual image. The object mask may be binary object mask (Mₒ(X)) and the counterfactual image pairs may be described as an input pair of the factual image and the binary object mask (X, Mₒ(X)), and the output counterfactual image (X^{cf}).

The diffusion module 208 estimates the distribution of the counterfactual images P(X^{cf}|X=x,Mₒ(X)) given the factual image x and the binary object mask by training the diffusion model based on using the counterfactual image pairs. The diffusion module 208 determines the estimation by minimizing a loss function [symbol] (θ) using the following equation:

$$ℒ ( θ ) = {𝔼}_{t ∼ U ( [ 0 , T ] , e ∼ 𝒩 ( 0 , I )} [ {\sum }_{i = 1}^{N} {‖ {D}_{θ} ( {α}_{i} {x}_{i}^{cf} + {σ}_{i} ε , {x}_{i} , {M}_{o} ( {x}_{i} ) , t , p ) - ϵ ‖}^{2} ] \qquad Eq . 1$$

where D_{θ}(\tilde{x}ₜ, x_{cond}, m, t, p) is a denoisier network with the following inputs: noised latent representation of the counterfactual image \tilde{x}ₜ, latent representation of the image containing the object to be removed x_{cond}, mask m indicating the object's location, timestamp t, and encoding of an empty string (text prompt) p. xₜ is calculated using the following forward process equation:

$${\tilde{x}}_{i} = {α}_{i} \cdot x + {σ}_{i} \cdot ϵ \qquad Eq . 2$$

where x represents the image without the object (the counterfactual), αₜ and σₜ are determined by the noising schedule, and ϵ˜ [symbol] (O, 1).

Once the diffusion model including an object removal model is trained, the user interface module 202 may receive a request to remove a selected object from the first modified image. An initial image and the request are provided as input to the object removal model, which outputs a modified image that does not include the selected object.

### Object Insertion Model

In some embodiments, instead of using the segmenter 204 to remove an object, using the inpainter module 206 to add pixels to the removed area in an initial image, and using the diffusion model 208 to blend the object with the pixels at a new location, the diffusion model 208 is trained to include an object insertion model.

In some embodiments, the object insertion model is trained on a number of image pairs that exceed the number of counterfactual image pairs that are available. As a result, the diffusion module 208 generates synthetic training data. For each synthetic image pair, the diffusion module 208 selects original images that include objects, uses the object removal model to output modified images from the original images without the objects, generates an input image by inserting the object into the modified image, and segments the original image to create the object masks. The modified images that lack the objects are referred to as z, using the following equation:

$${z}_{i} ∼ P ( {X}^{c f} \vert {x}_{i} , {M}_{o} ( {x}_{i} ) ) \qquad Eq . 3$$

where the original images are x₁, x₂, . . . , xₙ and the corresponding object masks are Mₒ(x₁), Mₒ(x₂), . . . , Mₒ(xₙ). The diffusion module 208 generates the input image by inserting the object into object-less scenes z; to result in images without shadows and reflections using the following equation:

$${y}_{i} = {M}_{o} ( {x}_{i} ) ⊙ {x}_{i} + ( 1 - {M}_{o} ( {x}_{i} ) ) ⊙ {z}_{i} \qquad Eq . 4$$

The synthetic image pairs are (yᵢ,Mₒ(xᵢ)) and the corresponding targets are the original images xᵢ. While both the input images and the output images contain the object o, the input images do not contain the effects of the object on the scene, while the output images do. In some embodiments, the diffusion module 208 trains the object insertion model with the diffusion objective presented in Equation 1.

For each synthetic image pair, the diffusion module 208 creates a second combined image that includes the original image and the object mask and the input image. The diffusion module 208 pre-trains the diffusion model to include an object insertion model based on using synthetic image pairs and fine-tunes the diffusion model to include the object insertion model based on using the counterfactual image pairs used to train the object removal model.

In some embodiments, the user interface module 202 generates graphical data for displaying a user interface that provides the user with the option to specify the location of the object and the option to resize the object. The diffusion module 208 adds a selected object that was removed from the initial image to the new location. In some embodiments, the diffusion module 208 provides the selected object as input to a diffusion model, as well as a location where the selected object will be located in a modified image, and outputs a modified image that blends the selected object with the inpainted image. For example, the diffusion module 208 may spatially blend noisy versions of the inpainted image with noisy versions of the selected object.

In some embodiments, the diffusion module 208 may add a shadow to the selected object in the new location. The shadow may match a direction of light in the image. For example, if the sun casts rays from the upper left-hand corner of the image, the shadow may be displayed to the right of the person and/or object. In some embodiments, the diffusion module 208 uses a machine-learning model to output a shadow mask that is used to generate the shadow attached to the object.

Once the selected object is added to the inpainted image, the user interface module 202 may include additional features for changing the inpainted image, such as an option to change the lighting of the inpainted image.

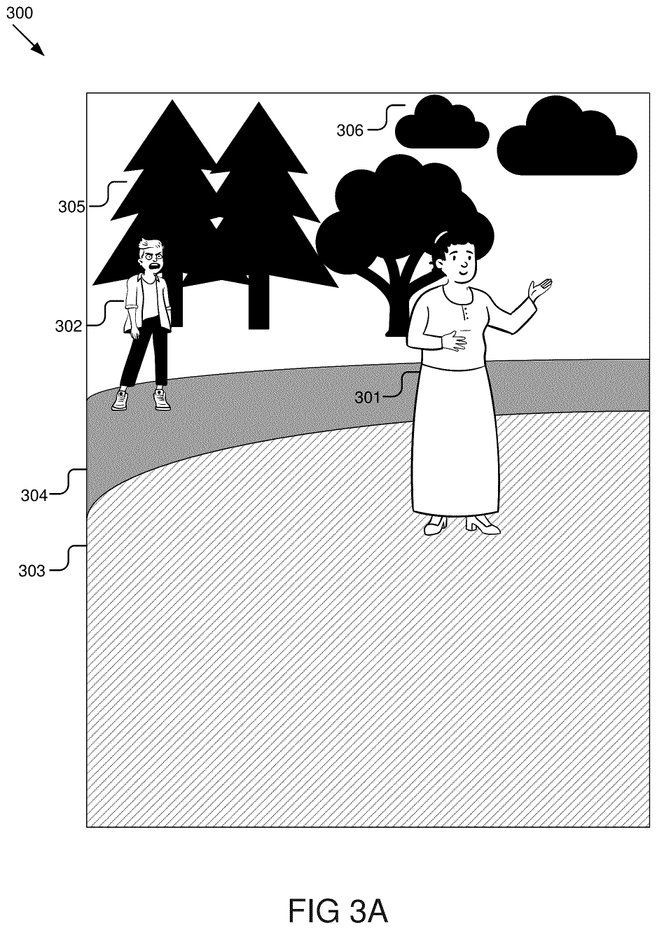

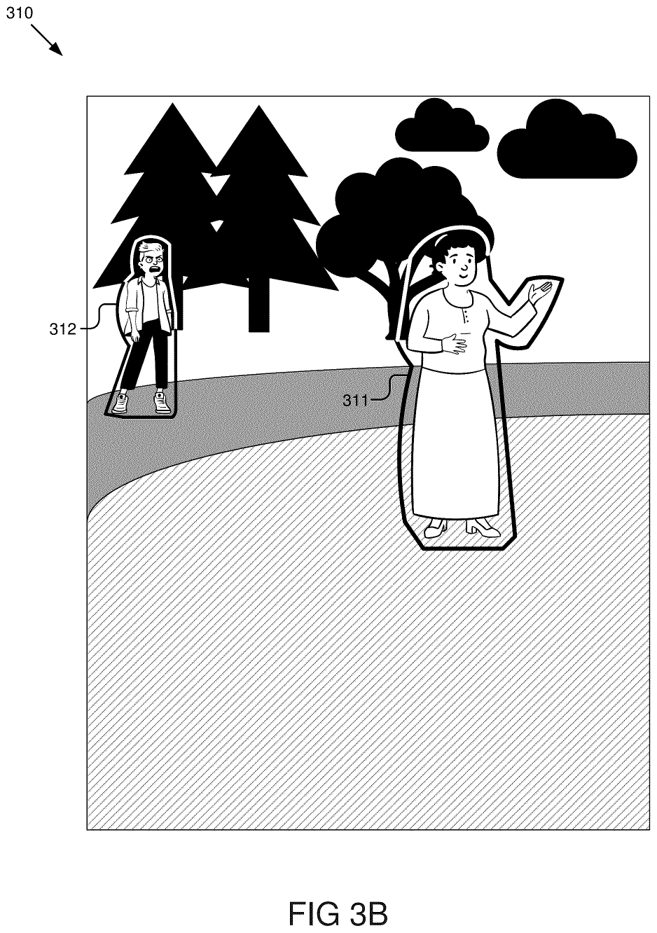

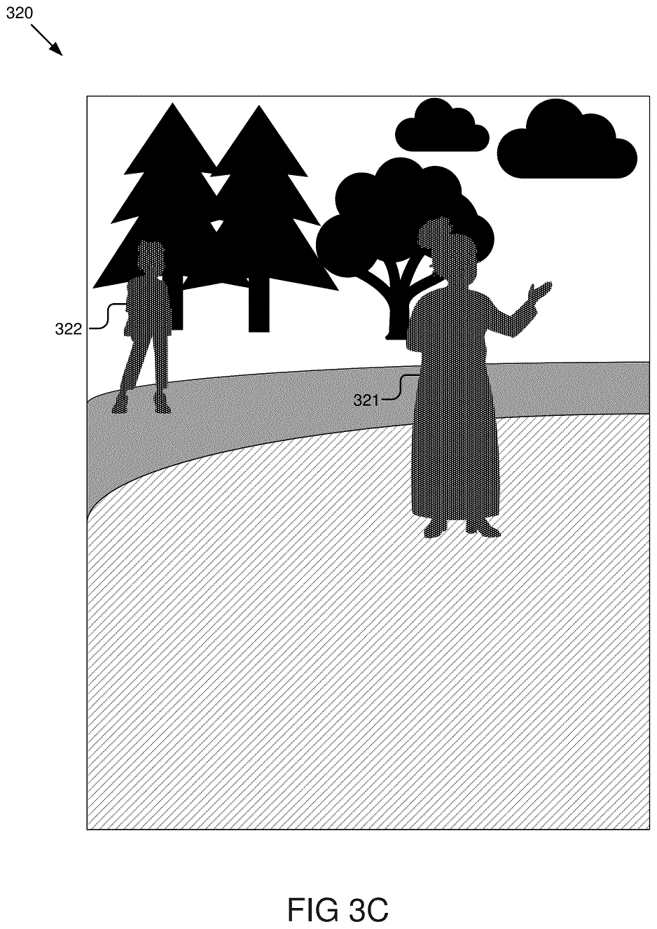

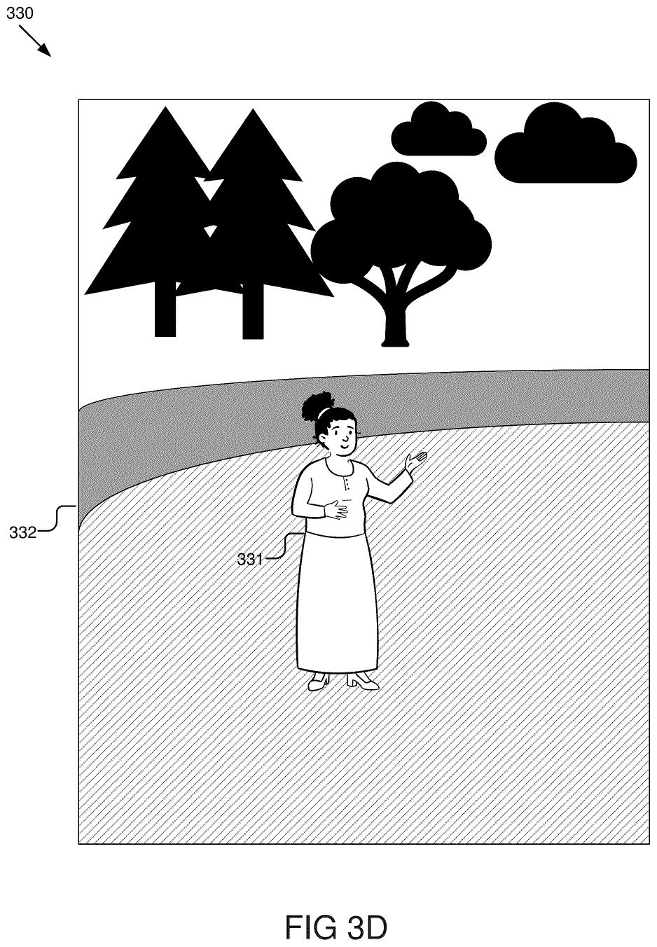

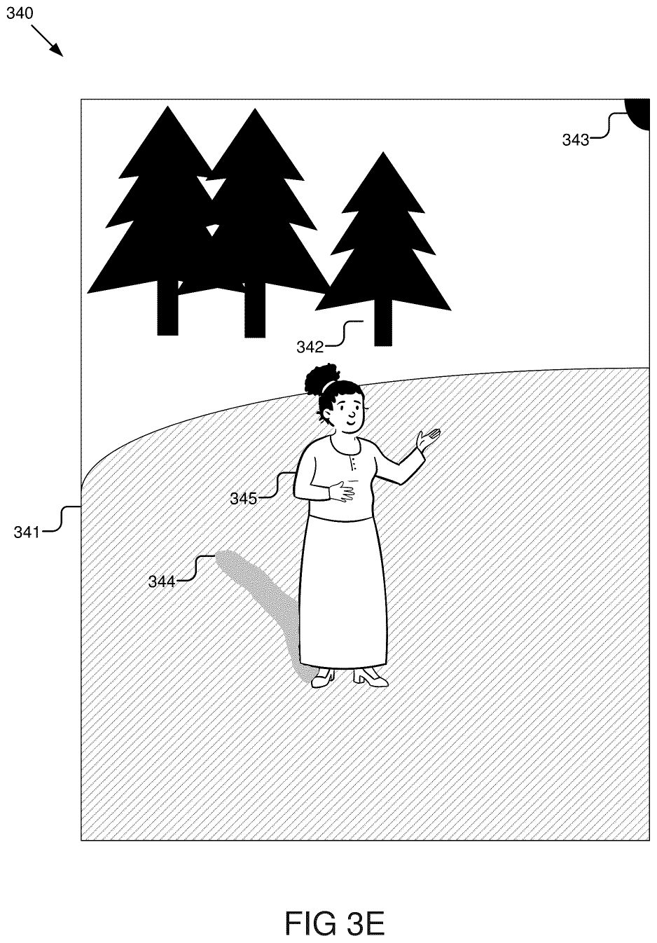

FIG. 3A illustrates an example initial image 300. The initial image includes a person 301 that is a subject of the initial image 300, a bystander 302 that is in the foreground of the initial image 300, grass 303, a road 304, trees 305, and a cloudy sky 306.

FIG. 3B illustrates an example initial image 310 where the two objects from FIG. 3A were selected for modification. The two objects are displayed with outlines 311, 312 of how the user selected the two objects. A user may have selected the two objects by using a finger, a mouse, or other object to circle, brush, double tap, etc. the two objects. The user interface module 202 may use an object selection tool, a lasso tool, an artificial intelligence segmentation tool, etc. to identify the object in the initial image 310. In some embodiments, the user interface module 202 may have suggested selecting the two objects and the two objects were highlighted responsive to the user confirming the selection.

Once the two objects are selected, a segmenter 204 segments the objects from the initial image 310 and generates objects masks. FIG. 3C illustrates an example initial image 320 with object masks 321, 322 surrounding the two objects. The person is surrounded by a first object mask 321 and the bystander is surrounded by a second object mask 322. The segmenter 204 removes the person and the bystander from the initial image 320.

Once the person and the bystander are removed from the initial image 320 of FIG. 3C, the inpainting module 206 generates an inpainted image that replaces object pixels corresponding to removed objects with inpainted pixels. FIG. 3D illustrates an example inpainted image 330 with the bystander from the initial image 320 removed and the person 331 moved and resized.

In some embodiments, the diffusion module 208 resizes objects to be larger or smaller than the object in the initial image. For example, the object may be resized to be larger when moved to the front or smaller when moved to the back. In this example, a user provided input to resize the person 331 to be smaller and the diffusion module 208 resized the person 331 as well as blended the person with the new location. In some embodiments, moving the person 331 may be a separate action from resizing or both moving and resizing may be part of the same action.

Additional changes may be made to the inpainted image. FIG. 3E illustrates an example inpainted image 340 with the road 332 from FIG. 3D replaced with grass 341. The inpainted image 340 also includes a first type of tree replaced with a second type of tree 342. The inpainted image 340 also includes the cloudy sky from FIG. 3D replaced with a sunny sky with sunlight 343 that originates from the upper right-hand corner of the sky. The direction of the sun 343 causes the diffusion module 208 to output a shadow 344 to match the person 345. In some embodiments, the road is replaced with grass 341 by outputting the grass with the diffusion module 208 and blending the grass with the inpainted image.

In some embodiments, the diffusion module 208 receives an incomplete object as input and outputs a complete object. The diffusion module 208 may also add the complete object to a second location within an inpainted image by blending complete object pixels corresponding to the complete object with inpainted pixels.

In some embodiments, if an object was captured at an edge of the image and a portion of the complete object was missing, the diffusion module 208 may complete the missing portions of the object before performing the blending. For example, if a woman has a long dress and a portion of the dress is missing, the diffusion module 208 may output a complete dress based on the incomplete dress.

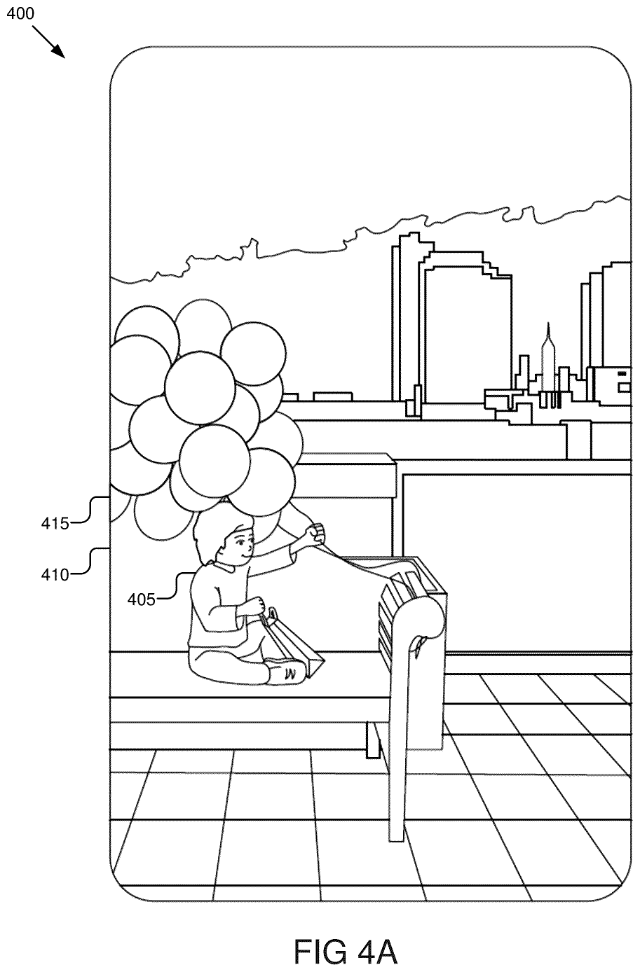

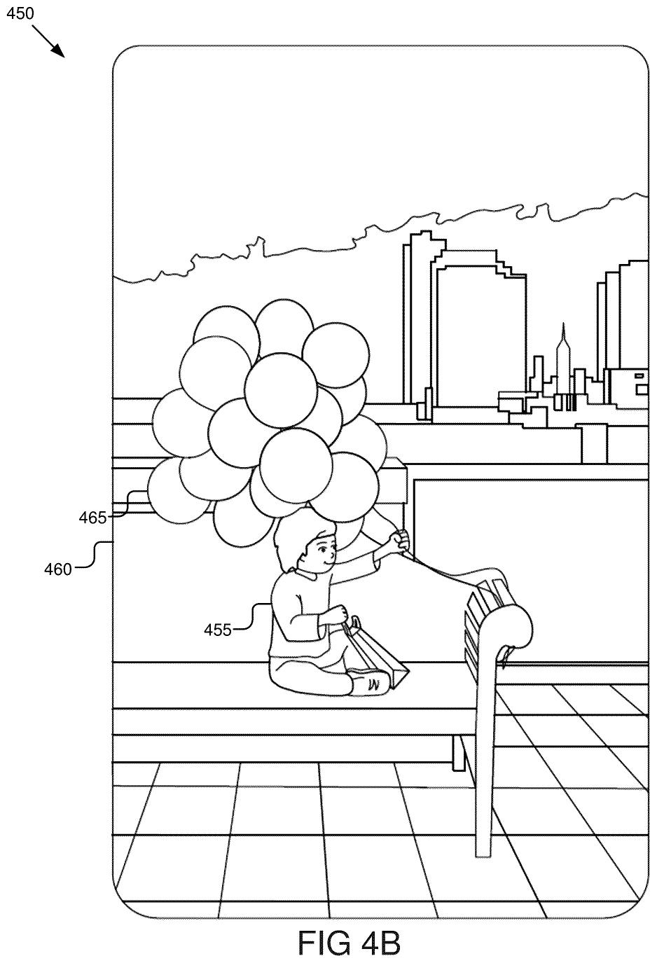

FIG. 4A illustrates an example initial image 400 of a child 405 sitting on a bench 410 and holding balloons 415 that are partially cut off by a boundary of the initial image 400. In this example, a user interface module 202 provides a user interface with an option for a user to select objects. The user selects the child 405, the bench 410, and the balloons 415 at a first location, where the balloons 415 represent an incomplete image. The segmenter 204 segments the child 405, the bench 410, and the balloons 415 to separate the objects from the initial image 400.

The user interface module 202 includes an option for moving the selected objects to a different location. The user selects a second location. The segmenter 204 removes the selected objects from the initial image. An inpainting module 206 generates an inpainted image that replaces object pixels corresponding to removed objects with inpainted pixels.

A diffusion module 208 receives as input the selected objects and coordinates for the second location and outputs balloons that are complete objects and a longer bench. FIG. 4B illustrates an example modified image 450 where the child 455, the bench 460, and the balloons 465 are moved to a second location. In this example, the diffusion module 208 outputs a modified image that blends one or more versions of the child 455, the bench 460, and the balloons 465 with one or more versions of the inpainted image using the object mask.

In some embodiments, the user interface module 202 receives a command to uncrop an image from the user interface. The command to uncrop the image may occur on a modified image, an initial image, etc. The command to uncrop the image may be a button that is part of a user interface that is a suggestion for helping to center an object, such as a person in the middle of an image. In some embodiments, the command may be based on a user specifying a new border for the image by directly extending the borders of the image or a movement of a selected object that extends the borders of the image.

The inpainter module 206 receives an uncropped image and dimensions for an uncropped image as input and outputs an uncropped image that replaces borders between the image and the uncropped image with inpainted pixels that match the image. For example, where the border is of water, the inpainter module 206 may use pixels of water for the uncropped portion of the image.

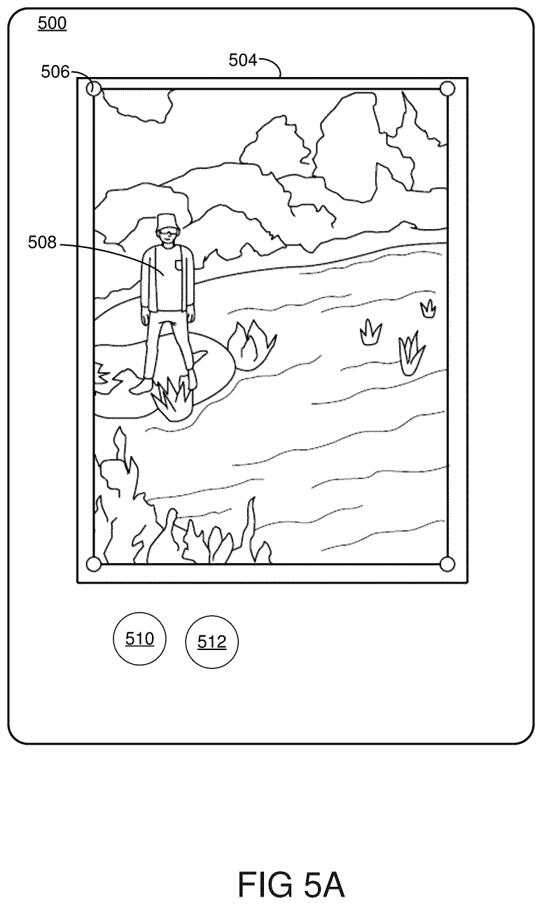

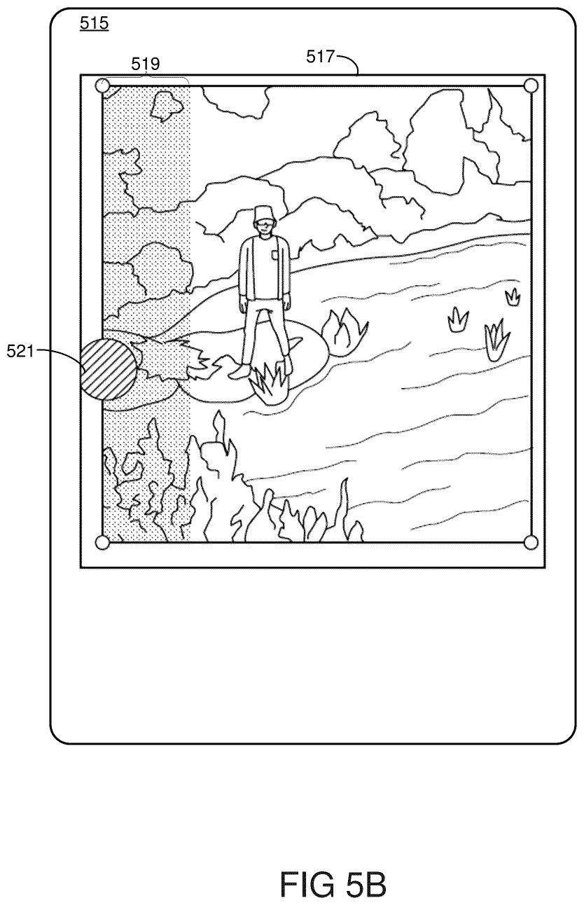

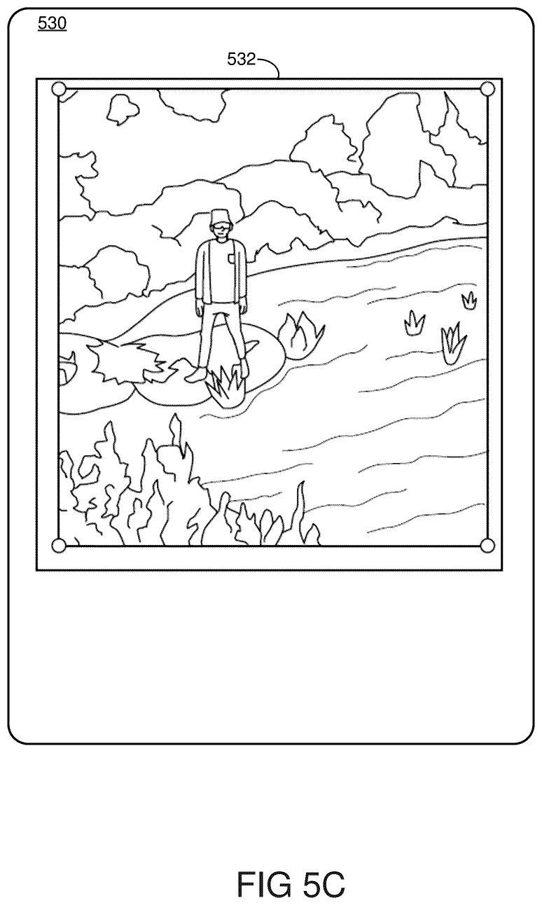

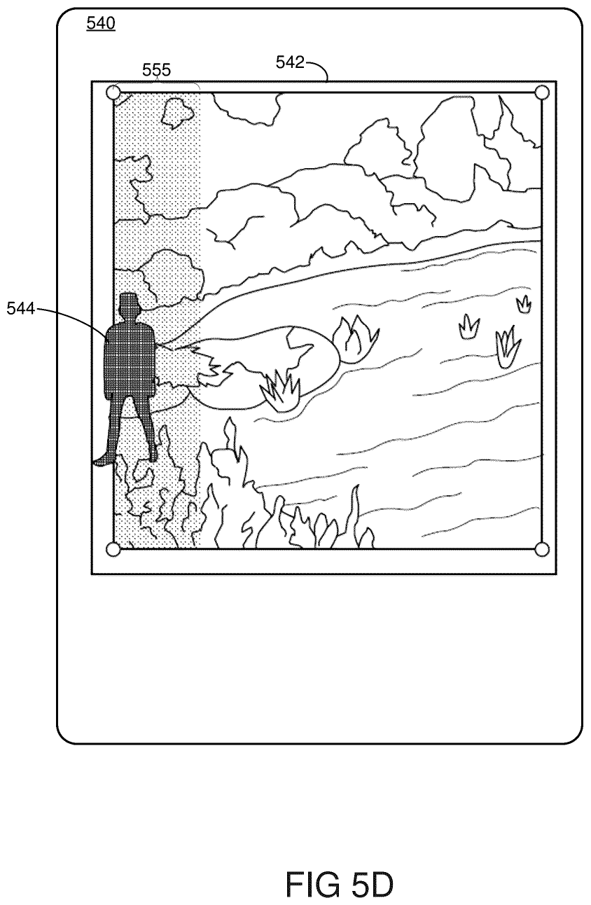

FIG. 5A illustrates an example user interface 500 of an initial image 504 that includes a button 412 for changing a border of an initial image 504. In this example, the user interface 500 includes a first button 510 for editing an image and a second button 512 for changing the borders of the image. Other mechanisms for providing commands to uncrop the image are possible. For example, a user may select an edge 506 of the initial image 504 and drag and drop the edge 506 to indicate where the user wants a new border to end.

The user may change the border of the initial image because the person 508 in the image is not centered in the image and cropping the image to reduce the image on the right would result in an image that is overly narrow.

FIG. 5B illustrates an example user interface 515 with an indicator 521 that is used to expand a border of the initial image 517. In this example the user has clicked and dragged the indicator 521 to expand the left-hand border of the initial image 517. The expanded area 519 is illustrated with pixelated content while the inpainter module 206 generated the uncropped image.

In some embodiments, the inpainter module 206 receives an uncropped image and dimensions for an uncropped image as input. For example, the dimensions include the length and width of the new border on the left side of the initial image.

The inpainter module 206 outputs an uncropped image that includes inpainted pixels between the uncropped borders of the modified image and the extended borders based on the dimensions. In this case, the inpainter module 206 copies pixels for shrubbery, a rock, water, and flowers. FIG. 5C illustrates an example user interface 530 of an uncropped image 532 that is output based on the initial image.

FIG. 5D illustrates an alternative example user interface 540 where a selected person 544 is used to extend uncropped borders of the initial image 542. In this alternative example, instead of using an indicator, such as the indicator 521 in FIG. 5B, or an edge of the border, such as the edge 506 in FIG. 5A, to extend the uncropped borders of the initial image 542, a user may select an object in the image and move the object to extend the border. In FIG. 5D, a user has moved the person 544 to the edge of the initial image 542. The new location of the person 544 defines the new edge to be generated for an uncropped image where 555 corresponds to the expanded area.

### Example Methods

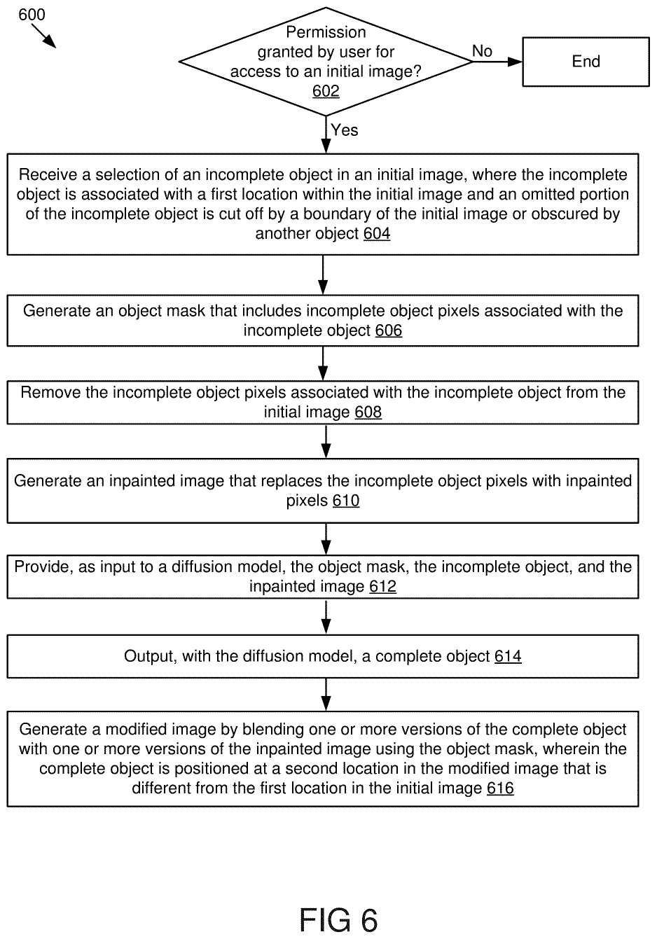

FIG. 6 illustrates an example flowchart of a method 600 to generate a modified image of a complete object from an incomplete object, according to some embodiments described herein. The method 600 may be performed by the computing device 200 in FIG. 2. In some embodiments, the method 600 is performed by the user device 115, the media server 101, or in part on the user device 115 and in part on the media server 101.

The method 600 of FIG. 6 may begin at block 602. At block 602, it is determined whether permission was granted by a user for access to an initial image. If permission was not granted, the method 600 ends. If permission was granted, block 602 may be followed by block 604.

At block 604, a selection of an incomplete object in an initial image is received, where the incomplete object is associated with a first location within the initial image and an omitted portion of the incomplete object is cut off by a boundary of the initial image or obscured by another object. For example, the incomplete object may be a car that is cut off by the edges of the initial image. A user may select the incomplete object by clicking on an object, circling an object, accepting a suggestion to modify an object generated by a user interface, etc. Block 604 may be followed by block 606.

At block 606, an object mask that includes incomplete object pixels associated with the incomplete object is generated. The incomplete object pixels may be determined by segmenting the initial image to identify pixels associated with the incomplete object in the initial object. Block 606 may be followed by block 608.

At block 608, the incomplete object pixels associated with the incomplete object are removed from the initial image. Block 608 may be followed by block 610.

At block 610, an inpainted image is generated that replaces incomplete object pixels with inpainted pixels. Block 610 may be followed by block 612.

At block 612, the object mask, the incomplete object, and the inpainted image are provided as input to a diffusion model. Block 612 may be followed by block 614.

At block 614, the diffusion model outputs a complete object. For example, the diffusion model may receive the incomplete object, a second location where the complete object is to be placed in a modified image, and dimensions of the complete object including resized dimensions if a user resized the incomplete object or the change from a first location to a second location results in a resizing of the incomplete object. Block 614 may be followed by block 616.

At block 616, a modified image is generated by blending one or more versions of the complete object with one or more versions of the inpainted image using the object mask, where the complete object is positioned at a second location in the modified image that is different from the first location in the initial image. Continuing with the example above, the complete image may include a complete version of the car. The car may be resized based on being moved from a foreground to the background and decreased in size to account for the distance reflected by being positioned in the background.

In some embodiments, the modified image is a first modified image and the method further includes receiving a request to remove a selected object from the first modified image; providing the first modified image and the request as input to an object removal model associated with the diffusion model; and outputting, with the object removal model, a second modified image that does not include the selected object. In some embodiments, the modified image is a first modified image and the method further includes receiving a request to move a selected object from a third location to a fourth location; providing the first modified image and the request as input to an object insertion model associated with the diffusion model; and outputting, with the object insertion model, a second modified image that includes the selected object at a fourth location based on the request.

In some embodiments, the method further includes receiving a request to add an additional object to the initial image; outputting, with the diffusion model, the additional object; and outputting, with the diffusion model, a modified image by blending one or more versions of the additional object with one or more versions of the inpainted image, wherein the additional object is positioned at a third location in the inpainted image that is different from the second location in the modified image. In some embodiments, the request to add the additional object includes a text prompt that describes the additional object and the diffusion model uses generative artificial intelligence to output the additional object.

In some embodiments, the selected person in the inpainted image may be resized to account for being moved forward or backward from the first location. For example, the selected person may be made smaller or bigger than the person in the initial image. In some embodiments, the diffusion model resizes the complete object based on a change from the first location in the initial image to the second location in the modified image.

A shadow may also be generated that corresponds to the selected person in the different location, where the shadow matches a direction of light in the image. In some embodiments, a first image in the initial image is replaced with a second object from the initial image, where the modified image includes the first object being replaced with the second object. In some embodiments, a lighting of the inpainted image is also changed. For example, the sky may be made lighter, darker, with thicker clouds to decrease illumination, etc. In some embodiments, the method further includes modifying a lighting of the modified image and adding a shadow to the complete object based on a direction of the lighting of the modified image.

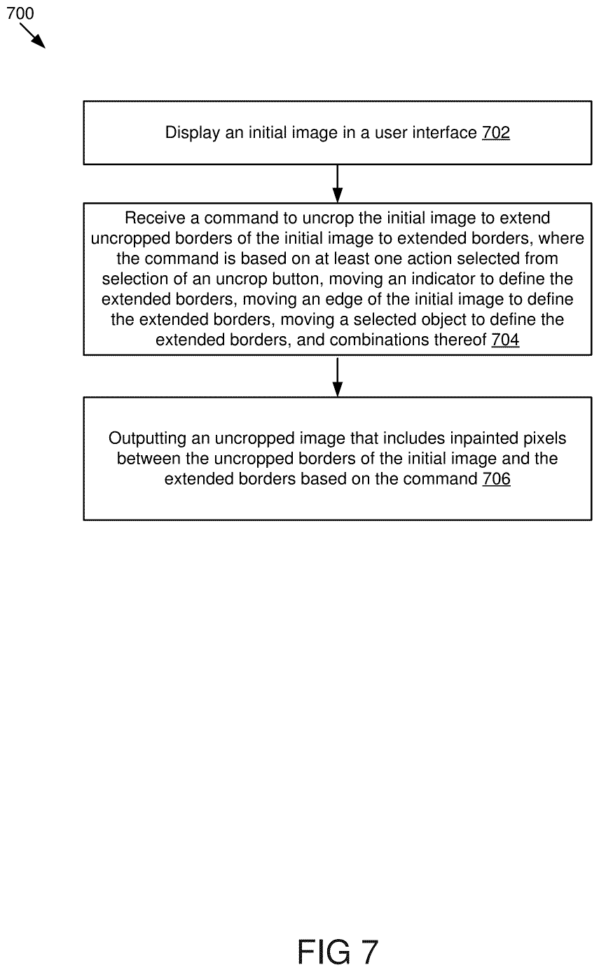

FIG. 7 illustrates an example flowchart of a method 700 to output an uncropped image from an initial image, according to some embodiments described herein. The method 700 may be performed by the computing device 200 in FIG. 2. In some embodiments, the method 700 is performed by the user device 115, the media server 101, or in part on the user device 115 and in part on the media server 101.

The method 700 of FIG. 7 may begin at block 702. At block 702, an initial image is displayed in a user interface. Block 702 may be followed by block 704.

At block 704, a command is received to uncrop the initial image to extend uncropped borders of the initial image to extended borders, where the command is based on at least one action selected from the group of selection of an uncrop button, moving an indicator to define the extended borders, moving an edge of the initial image to define the extended borders, moving a selected object to define the extended borders, and combinations thereof. Block 704 may be followed by block 706.

At block 706, an uncropped image is output that includes inpainted pixels between the uncropped borders of the initial image and the extended borders based on the command.

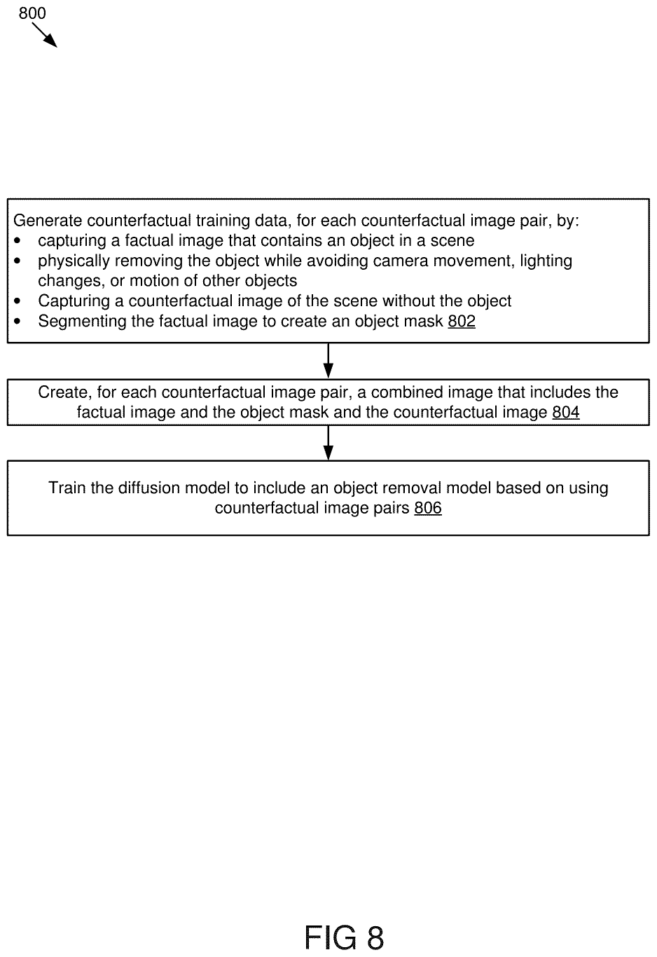

FIG. 8 illustrates an example flowchart of a method 800 to train an object removal model, according to some embodiments described herein. The method 800 may be performed by the computing device 200 in FIG. 2. In some embodiments, the method 800 is performed by the user device 115, the media server 101, or in part on the user device 115 and in part on the media server 101.

The method 800 may begin at block 802. At block 802 counterfactual training data is generated for each counterfactual image pair by: capturing a factual image that contains an object in a scene; physically removing the object while avoiding camera movement, lighting changes, or motion of other objects; capturing a counterfactual image of the scene without the object; and segmenting the factual image to create an object mask. Block 802 may be followed by block 804.

At block 804, for each counterfactual image pair a combined image is created that includes the factual image and the object mask and the counterfactual image. Block 804 may be followed by block 806.

At block 806, the diffusion model is trained to include an object removal model based on using counterfactual image pairs.

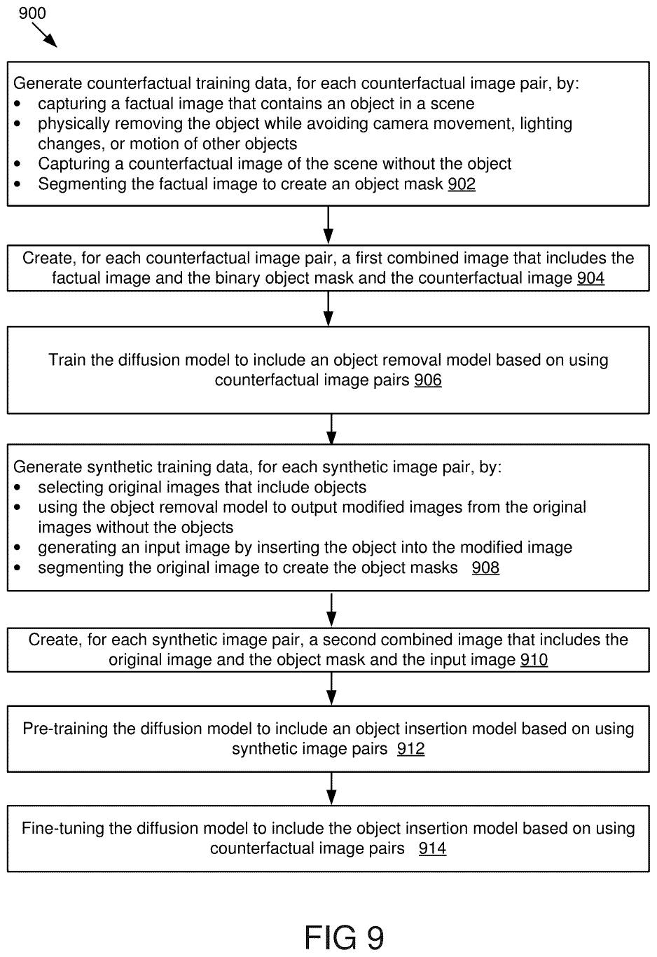

FIG. 9 illustrates an example flowchart of a method 900 to train an object insertion model, according to some embodiments described herein. The method 900 may be performed by the computing device 200 in FIG. 2. In some embodiments, the method 900 is performed by the user device 115, the media server 101, or in part on the user device 115 and in part on the media server 101.

The method 900 may begin at block 902. At block 902 counterfactual training data is generated for each counterfactual image pair by: capturing a factual image that contains an object in a scene; physically removing the object while avoiding camera movement, lighting changes, or motion of other objects; capturing a counterfactual image of the scene without the object; and segmenting the factual image to create an object mask. Block 902 may be followed by block 904.

At block 904, for each counterfactual image pair a combined image is created that includes the factual image and the object mask and the counterfactual image. Block 904 may be followed by block 906.

At block 906, the diffusion model is trained to include an object removal model based on using counterfactual image pairs. Block 906 may be followed by block 908.

At block 908, synthetic training data is generated for each synthetic image pair by: selecting original images that include objects; using the object removal model to output modified images from the original images without the objects; generating an input image by inserting the object into the modified image; and segmenting the original image to create the object masks. Block 908 may be followed by block 910.

At block 910, for each synthetic pair, a second combined image is created that includes the original image and the object mask and the input image. Block 910 may be followed by block 912.

At block 912, the diffusion model is pre-trained to include an object insertion model based on using synthetic image pairs. Block 912 may be followed by block 914.

At block 914, the diffusion model is fine-tuned to include the object insertion model based on using counterfactual image pairs.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving a selection of an incomplete object in an initial image, wherein the incomplete object is associated with a first location within the initial image and an omitted portion of the incomplete object is cut off by a boundary of the initial image or obscured by another object;
generating an object mask that includes incomplete object pixels associated with the incomplete object;
removing the incomplete object pixels associated with the incomplete object from the initial image;
generating an inpainted image that replaces the incomplete object pixels corresponding to the incomplete object with inpainted pixels;
providing, as input to a diffusion model, the object mask, the incomplete object, and the inpainted image;
outputting, with the diffusion model, a complete object; and
generating a modified image by blending one or more versions of the complete object with one or more versions of the inpainted image using the object mask, wherein the complete object is positioned at a second location in the modified image that is different from the first location in the initial image.

2. The method of claim 1, wherein the modified image is a first modified image and further comprising:
receiving a request to remove a selected object from the first modified image;
providing the first modified image and the request as input to an object removal model associated with the diffusion model; and
outputting, with the object removal model, a second modified image that does not include the selected object.

3. The method of claim 1, wherein the modified image is a first modified image and further comprising:
receiving a request to move a selected object from a third location to a fourth location;
providing the first modified image and the request as input to an object insertion model associated with the diffusion model; and
outputting, with the object insertion model, a second modified image that includes the selected object at the fourth location based on the request.

4. The method of claim 1, wherein the modified image is a first modified image and further comprising:
receiving a request to add an additional object to the initial image;
outputting, with the diffusion model, the additional object; and
outputting, with the diffusion model, a second modified image by blending one or more versions of the additional object with one or more versions of the inpainted image.

5. The method of claim 4, wherein the request to add the additional object includes a text prompt that describes the additional object.

6. The method of claim 1, wherein the complete object is resized based on a change from the first location in the initial image to the second location in the modified image.

7. The method of claim 1, further comprising:
receiving a command to uncrop the modified image to extend uncropped borders of the modified image to extended borders; and
outputting an uncropped image that includes inpainted pixels between the uncropped borders of the modified image and the extended borders based on the command.

8. The method of claim 7, wherein the command to uncrop the inpainted image includes:
a selection of an uncrop button; and
either a command to directly extend the uncropped borders of the modified image to the extended borders or a movement of the complete object that extends the uncropped borders of the modified image to the extended borders.

9. The method of claim 1, further comprising:
modifying a lighting of the modified image; and
adding a shadow to the complete object based on a direction of the lighting of the modified image.

10. A non-transitory computer-readable medium with instructions stored thereon that, when executed by one or more processors, cause the one or more processors to perform operations comprising:
receiving a selection of an incomplete object in an initial image, wherein the incomplete object is associated with a first location within the initial image and an omitted portion of the incomplete object is cut off by a boundary of the initial image or obscured by another object;
generating an object mask that includes incomplete object pixels associated with the incomplete object;
removing the incomplete object pixels associated with the incomplete object from the initial image;
generating an inpainted image that replaces the incomplete object pixels corresponding to the incomplete object with inpainted pixels;
providing, as input to a diffusion model, the object mask, the incomplete object, and the inpainted image;
outputting, with the diffusion model, a complete object; and
generating a modified image by blending one or more versions of the complete object with one or more versions of the inpainted image using the object mask, wherein the complete object is positioned at a second location in the modified image that is different from the first location in the initial image.

11. The non-transitory computer-readable medium of claim 10, wherein the modified image is a first modified image and the operations further include:
receiving a request to remove a selected object from the first modified image;
providing the first modified image and the request as input to an object removal model associated with the diffusion model; and
outputting, with the object removal model, a second modified image that does not include the selected object.

12. The non-transitory computer-readable medium of claim 10, wherein the modified image is a first modified image and the operations further include:
receiving a request to move a selected object from a third location to a fourth location;
providing the first modified image and the request as input to an object insertion model associated with the diffusion model; and
outputting, with the object insertion model, a second modified image that includes the selected object at the fourth location based on the request.

13. The non-transitory computer-readable medium of claim 10, wherein the modified image is a first modified image and the operations further include:
receiving a request to add an additional object to the initial image, the request including a text prompt that describes the additional object;
outputting, with the diffusion model, the additional object; and
outputting, with the diffusion model, a second modified image by blending one or more versions of the additional object with one or more versions of the inpainted image.

14. The non-transitory computer-readable medium of claim 10, wherein the operations further include:
receiving a command to uncrop the modified image to extend uncropped borders of the modified image to extended borders; and
outputting an uncropped image that includes inpainted pixels between the uncropped borders of the modified image and the extended borders based on the command.

15. A system comprising:
a processor, and
a memory coupled to the processor, with instructions stored thereon that, when executed by the processor, cause the processor to perform operations comprising:
receiving a selection of an incomplete object in an initial image, wherein the incomplete object is associated with a first location within the initial image and an omitted portion of the incomplete object is cut off by a boundary of the initial image or obscured by another object;
generating an object mask that includes incomplete object pixels associated with the incomplete object;
removing the incomplete object pixels associated with the incomplete object from the initial image;
generating an inpainted image that replaces the incomplete object pixels corresponding to the incomplete object with inpainted pixels;
providing, as input to a diffusion model, the object mask, the incomplete object, and the inpainted image;
outputting, with the diffusion model, a complete object; and
generating a modified image by blending one or more versions of the complete object with one or more versions of the inpainted image using the object mask, wherein the complete object is positioned at a second location in the modified image that is different from the first location in the initial image.

16. The system of claim 15, wherein the modified image is a first modified image and the operations further include:
receiving a request to remove a selected object from the first modified image;
providing the first modified image and the request as input to an object removal model associated with the diffusion model; and
outputting, with the object removal model, a second modified image that does not include the selected object.

17. The system of claim 15, wherein the modified image is a first modified image and the operations further include:
receiving a request to move a selected object from a third location to a fourth location;
providing the first modified image and the request as input to an object insertion model associated with the diffusion model; and
outputting, with the object insertion model, a second modified image that includes the selected object at the fourth location based on the request.

18. The system of claim 15, wherein the modified image is a first modified image and the operations further include:
receiving a request to add an additional object to the initial image, the request including a text prompt that describes the additional object;
outputting, with the diffusion model, the additional object; and
outputting, with the diffusion model, a second modified image by blending one or more versions of the additional object with one or more versions of the inpainted image.

19. The system of claim 15, wherein the complete object is resized based on a change from the first location in the initial image to the second location in the modified image.

20. The system of claim 15, wherein the operations further include:
receiving a command to uncrop the modified image to extend uncropped borders of the modified image to extended borders; and
outputting an uncropped image that includes inpainted pixels between the uncropped borders of the modified image and the extended borders based on the command.
